(19) United States
(12) Patent Application Publication
(10) Pub. No.: US 2004/0015407 A1
(43) Pub. Date: Jan. 22, 2004

(54) Method of ordering prints of digital photographs stored online

(75) Inventors: Milton S. Sales, Webster, NY (US); Nelson A. Blish, Rochester, NY (US); Dana W. Wolcott, Honeoye Falls, NY (US); Roland R. Schindler II, Pittsford, NY (US); Loretta E. Allen, Hilton, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/196,809

(22) Filed: Jul. 16, 2002

(51) Int. Cl. G06F 17/60

(52) U.S. Cl. 705/26

(57) ABSTRACT

A method of ordering prints of digital photographs stored online comprises storing the digital photographs in an online album (34). The album owner (12) enters their credit card information (38) online. The album owner transmits an Internet link (26) to at least one viewer (37) and notifies at least one viewer that photographic prints (30) ordered from the online album (34) have been prepaid.

### FIELD OF THE INVENTION

The present invention relates in general to the field of photo processing and, more particularly, to the selection and ordering of photographic prints and other image related services.

### BACKGROUND OF THE INVENTION

It is natural for photographers to want to share their photographs with others. Using film based systems this has often proven difficult. The photographer often must determine which small negatives that accompany her print photographs relate to the desired additional prints, deliver those negatives to a photo finisher, return to pick up the additional finished prints, and mail the prints to friends and relatives. Besides being work intensive, it is often difficult to determine which number printed on an edge of a negative relates to a particular frame of the negative. Index prints, delivered with the finished photographs, have made the process of ordering additional prints easier, but are not a complete solution.

Various attempts to alleviate this distribution problem have been disclosed in U.S. Pat. Nos. 5,666,215; 6,017,157; and 6,133,985. U.S. Pat. No. 5,666,215, for example, discloses the process of sending photographic negatives to a photo finisher, the photo finisher digitizes the images and transmits a display file to the customer, the customer selects the desired print and transmits the order information to the photo finisher for making prints. U.S. Pat. No. 6,017,157 associates an authorization code with the digitized images, and U.S. Pat. No. 6,133,985 transmits digital images from a digital camera to a central server location. While these patents provide a significant increase in the ease of distributing photographs, there is still room for improvement.

In a more recent development many consumers store digital photographs online. These digital photographs are often grouped in electronic online albums and shared with family and friends. The number of photographic prints ordered by those who view online digital photographs, however, is relatively low. This may be due to a number of factors. For example, entering a credit card number online to purchase a photographic print may deter viewers of online digital photographic albums from purchasing prints since a viewer may be reluctant to transmitting a credit card number over the Internet where it may be intercepted and used by a third party. The reluctance of the viewer to purchase prints from an online electronic album may also be due to monetary considerations. The viewer may not wish to spend her money or may not have discretionary income to spend.

There is a need to facilitate ordering of photographic prints by authorized viewers of online albums. There is also a need for simplifying the process by which viewers of online albums elect to receive photographic prints.

### SUMMARY OF THE INVENTION

Briefly, according to one aspect of the present invention a method of ordering prints of digital photographs stored online comprises storing the digital photographs in an online album. The album owner enters credit card information online and transmits an Internet link to at least one viewer. The viewer is notified that photographic prints ordered from the online album have been prepaid. The viewer then orders prepaid prints for delivery.

In one embodiment of the present invention, the album owner enters a credit card number into her online account, against which a plurality of preselected album viewers can order print photographs. The album owner then transmits a link to individuals she wishes to view her online album. The link includes a notice that photographic prints selected by the viewer have been prepaid and it is only necessary for the viewer to select which prints she would like to order. The link to the online album may also be sent to the viewer by the third party service provider who stores the online album.

An advantage of this invention is that it will increase the number of photographic prints ordered from the online albums, since the viewer does not incur fees, and does not have to enter a credit card number for transmission over the Internet. This may also increase the number of people with whom the album owner shares the online album, since the online album owner will not feel that she is asking friends or relatives to purchase photographic prints. The owner of the online album will be paying for the prints using this method and will feel less shy about increasing distribution of her online album.

In another embodiment, a dollar amount limit is pre-selected by the album owner for each viewer prior to distribution of the online album. In yet another embodiment, a total dollar amount limit is set for each album regardless of the number of individual viewer orders placed for photographic prints. In a further embodiment, dollar matching for orders is selected by the album owner, and viewers pay a portion of the cost of the prints. In yet another embodiment, a personal identification number (PIN) is pre-selected by the album owner and distributed to family members and friends in order to access the prepaid photographic prints.

In an additional embodiment, index prints are distributed in the form of a postcard and include a website for ordering any of the prints in the index. Print orders are charged against an account established by the online album owner. A toll-free 800 number is also included on the postcard for placing orders for photographic prints by those who do not have access to computers. Orders placed using the toll-free number are also billed against the album owner's account. Since postcards are more open to indiscriminate viewing than e-mail, PIN numbers to the online album are distributed separately. In yet another embodiment, the index print postcard is enclosed in an envelope, mailed to the viewer, the viewer selects which prepaid prints she would like to receive, and mails the preaddressed index postcard to a processor, who in turn mails the selected prints back to the viewer.

In yet another embodiment of the present invention, the owner of the online album or index postcard pre-enters all information relating to the transaction to reduce the amount of work required by the viewer. For example, the viewer's mailing address is entered by the online album owner to relieve the viewer of the additional task of entering mailing and address information.

The invention and its objects and advantages will become more apparent in the detailed description of the preferred embodiment presented below.

### BRIEF DESCRIPTION OF THE DRAWINGS

FIG. 1 is a schematic showing a method for storing photographs online.

FIG. 2 is a schematic showing an alternate method of storing photographs online.

FIG. 3 is a schematic of a method for prepaying for photographic prints ordered by a viewer from an online digital album.

FIG. 4 is a schematic of another method for prepaying for photographic prints ordered by viewer using an index print postcard.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

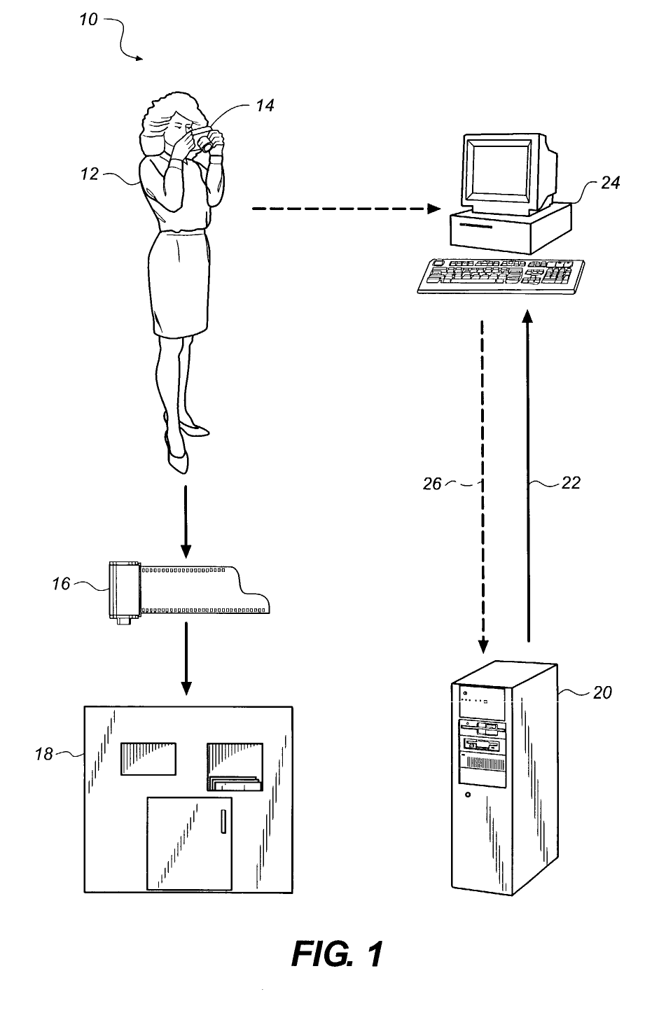

Referring now to FIG. 1, a system 10 for storing photographs in an online album is shown. The album owner 12 takes a photograph with camera 14. If the photograph is taken on a roll of film 16, the film is delivered to a film processor 18 to be developed. The film processor 18 transmits digital copies of the photographs to an online server 20. The online server 20 stores the digital photographs in an online album. An electronic link 22 to the online album is sent to the album owner 12, which the album owner receives on her computer 24.

If the camera 14 is a digital camera, the album owner 12 may enter the digital photographs on her computer 24. The digital photographs are transmitted electronically 26 to the online server 20. Alternatively, the digital photographs may be submitted directly from the camera 14 to the online server 20, by passing the computer 24.

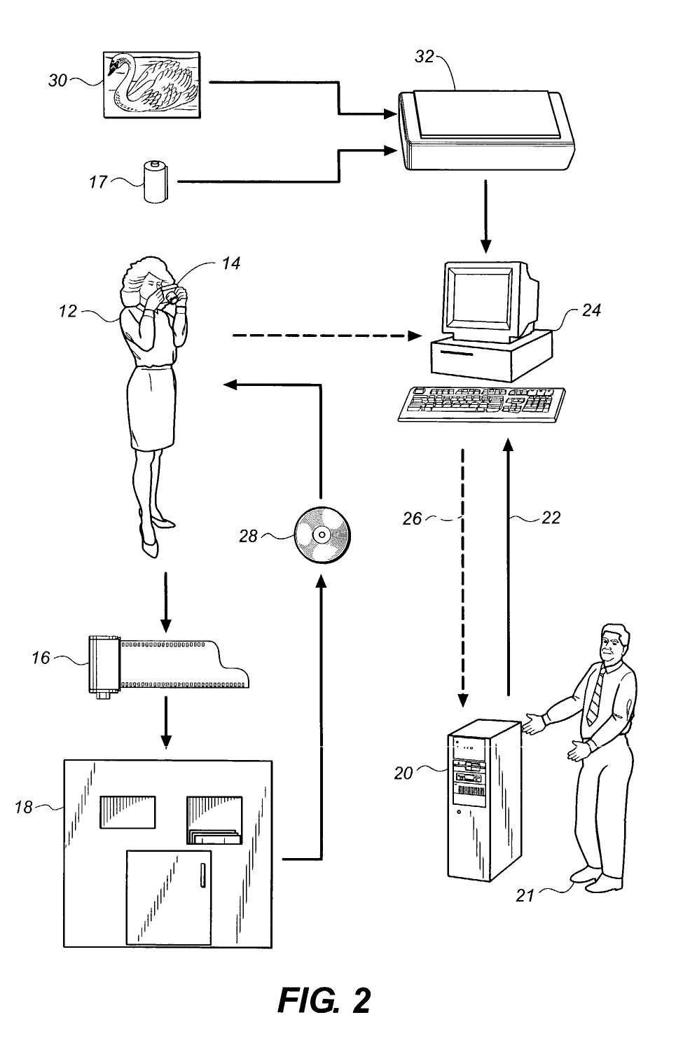

There are other embodiments for storing digital photographs in an online album. For example, FIG. 2 shows a digital copy of photographs stored on a Picture CD 28, which is returned to the album owner 12 by the film processor 18. The album owner then uploads digital photographs from the Picture CD 28 to her computer 24. The digital photographs are then transmitted electronically 26 from computer 24 to the online server 20. The album owner 12 may also use a scanner 32 to digitized photographic prints 30 or developed film 17. The digitized photographs are then stored on computer 24 for uploading to online server 20 operated by a service provider 21.

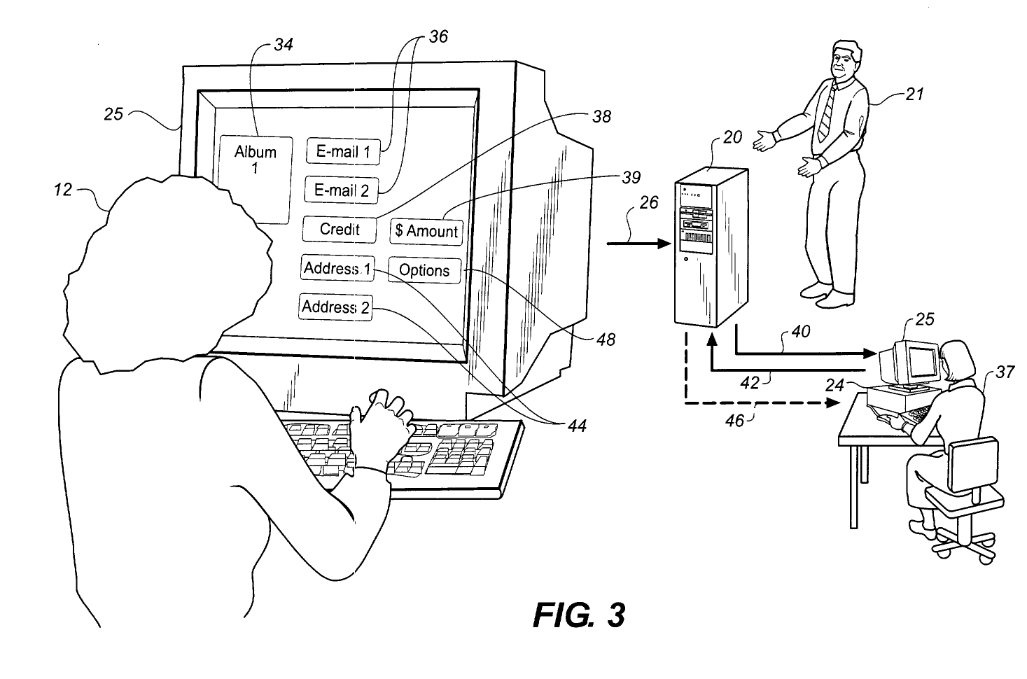

After the digital photographs have been stored online in an album 34, album owner 12 may view her digital photographs online as shown in FIG. 3. The online album is viewed on a monitor 25 of computer 24. The album owner 12 enters e-mail addresses 36 for each viewer with whom she wishes to share her album 34 and transmits electronically 26 that information to the online server 20. The online server 20 transmits an electronic link 40 for online album 34 to a computer 24 operated by a viewer 37. Alternatively, thumbnail images may be transmitted in lieu of transmitting electronic link 40.

Viewer 37 may submit an order 42 for photographic prints 30 to the online server 20. Viewer 37 typically pays for the prints that she orders by entering her credit card number online and transmitting credit card information to the online service provider 21 in conjunction with her order 42. The online service provider 21 then provides photographic prints 30 to viewer 37, usually through the mail 46.

If the album owner 12, however, wishes to prepay for photographic prints 30 which are ordered by a viewer, she enters her credit card information 38 which is transmitted to the online server 20 for use by the service provider 21. The album owner 12 may also enter an address 44 for one or more viewers. This reduces the number of steps required by the viewer 37, and increases the probability that photographic prints will be ordered. The viewer 37 receives online notification containing a message indicating that photographic prints ordered from the online album have been prepaid, and also an electronic link to the album. Prepayment options by the album owner includes credit cards, debit cards, conventional checks, Passport®, PayPal®, and other payment means.

In one embodiment, the prepayment may be for only certain photographs, or for a total dollar amount 39. In yet another embodiment, the viewer 37 may be required to pay a portion of the cost of the album or shipping cost. These options 48 would be available to the album owner 12 through separate menu listings. After reviewing the information provided by the online server 20, including address information, the viewer 37 places an order 42 for photographic prints 30.

The album owner 12 may transmit an Internet link, or other means, to multiple viewers. As discussed above, various payment options may be selected. For example, the album owner 12 may select prepayment for some viewers, and for other viewers may elect only to share the album online, with viewers covering the cost of their own print orders. Alternatively, the album owner 12 may elect to cover the cost of the prints and require the viewer 37 to pay postage costs. Any combination of the above described options are feasible.

In another embodiment, in order to access the prepaid photographic print option, a personal identification number (PIN) is pre-selected by the album owner and distributed to family members and friends. The PIN may be distributed in conjunction with or separately from the electronic link to the online album 34.

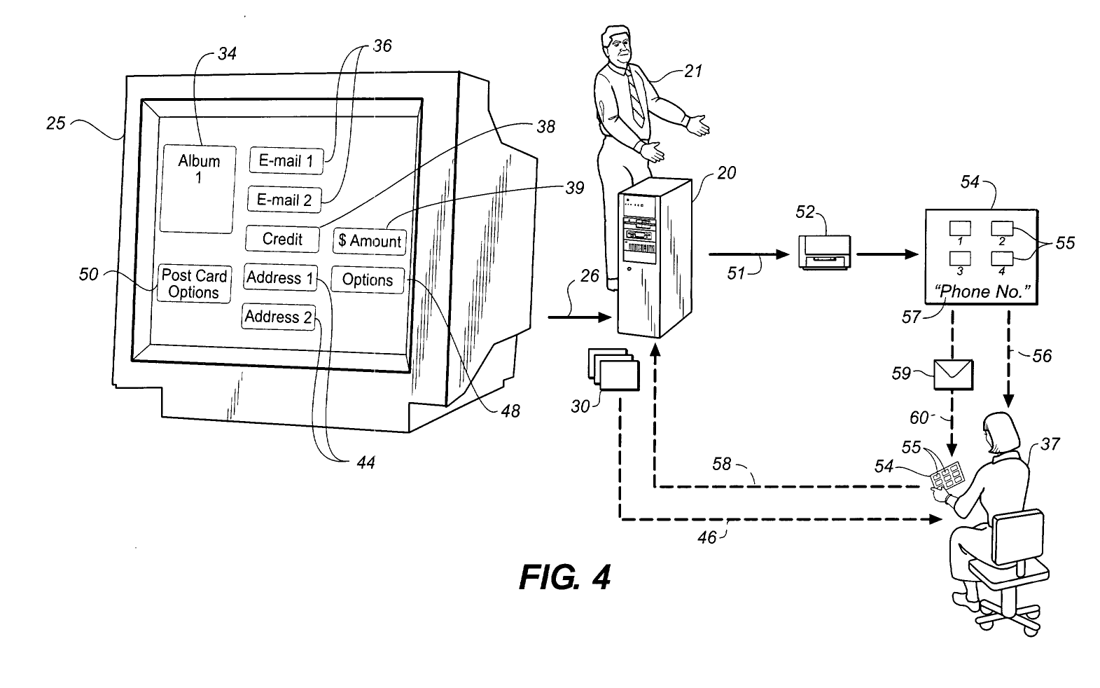

On occasion, individuals to whom the album owner 12 wishes to distribute copies of her online album 34 do not have access to a computer. In this case as is shown in FIG. 4, album owner 12 may select postcard option 50. If the postcard option is selected, entry of at least one address 44 for at least one viewer will be mandatory. The postcard option 50 may be selected for some viewers or all viewers. If the postcard option is selected for some viewers, an electronic link 56 may still be sent to other viewers via e-mail. The album owner 12 would enter her credit card information 38, selected dollar amount 39, and additional options 48.

When the postcard option is selected, the order is transmitted electronically 26 to online server 20. Online server transmits information 51 to printer 52 which prints an index print 54. The index print 54 may contain the entire contents of the online album 34, or a may contain only selected photographs chosen by the album owner 12. Thumbnail images 55 on the index print 54 are miniaturized copies of the original digital photographs.

The index print 54 is mailed 60 to viewer 37. When the viewer 37 receives the index print 54 postcard, she orders 58 copies of photographic prints 30 from the online service provider 21.

There are several methods of ordering online prints. One method is to place a telephone call to online service provider 21 using a phone number 57 on the index print 54. A toll-free number may be used for this purpose to further reduced costs to the viewer. The viewer then orders selected photographic prints 30 from the index print 54. The photographic prints 30 are then mailed 46 to viewer 37.

In another embodiment, the index print 54 includes an U.S. postage stamp, and is preaddressed to the online service provider 21. The index print 54 is enclosed in envelope 59 and mailed to the viewer 60. The viewer 37 selects the photographic prints 30 she would like to receive by circling or otherwise marking the thumbnail images 55 on the index print. The index print postcard is then mailed to the online service provider 21.

An advantage of this invention is that it will increase the number of photographic prints ordered from the online albums, since the viewer does not incur fees and does not have to enter a credit card number for transmission over the Internet. This may also increase the number of people with whom the album owner shares the online album, since the online album owner will not feel that she is asking friends or relatives to purchase photographic prints. The owner of the online album will be paying for the prints using this method and will feel less shy about increasing distribution of her online album.

An additional benefit is that the online album may be shared with viewers who do not have access to computers, or who are computer illiterate. This is done through an index postcard and a system of charging photographic prints ordered to the online album owner.

The invention has been described in detail with particular reference to certain preferred embodiments thereof, but it will be understood that variations and modifications can be effected within the scope of the invention. For example, personal digital assistants (PDAs) may be used in place of computers for the purpose of this invention. Also, cameras with LED screens and other electronic devices may be used in place of computers. In a similar manner, viewers may receive electronic links to online photograph albums through PDAs, cellphone screens, or other electronic devices in place of computers.

### Parts List

10 System

12 Album owner

14 Camera

16 Roll of film

17 Developed film

18 Film processor

20 Online server

21 Service provider

22 Electronic link

24 Computer

25 Monitor

26 Electronic transmission

28 Picture CD

30 Photographic print

32 Scanner

34 Online album

36 E-mail addresses

37 Viewer

38 Credit card information

39 Dollar amount

40 Electronic link

42 Order

44 address

46 Mail

48 Options

50 Postcard option

51 Information transmission

52 Printer

54 Index print

55 Thumbnail images

56 Electronic link

57 Phone number

58 Order

59 Envelope

60 Mailed to viewer

What is claimed is:

1. A method of ordering prints of digital photographs stored online comprising:
storing digital photographs in an online album;
entering album owner credit card information online;
transmitting an Internet link to at least one viewer; and
notifying said at least one viewer that photographic prints ordered from said online album have been prepaid.

2. The method of ordering prints of digital photographs stored online as in claim 1 wherein said album owner pre-selects a dollar amount limit per viewer.

3. The method of ordering prints of digital photographs stored online as in claim 1 wherein said album owner selects a total dollar amount limit for all viewers of said online album.

4. The method of ordering prints of digital photographs stored online as in claim 1 wherein said viewer shares a portion of a cost of photographic prints ordered from said online album.

5. The method of ordering prints of digital photographs stored online as in claim 1 wherein said album owner enters mailing address information for said viewer.

6. The method of ordering prints of digital photographs stored online as in claim 1 wherein an index print postcard is mailed to said viewer.

7. A system of increasing print orders for digital photographs stored online comprising:
storing digital photographs in an online album;
entering album owner credit card information online;
transmitting an Internet link to at least one viewer;
notifying said viewer that photographic prints ordered from said online album have been prepaid;
taking an order from said viewer for photographic prints; and
delivering said photographic prints to said viewer.

8. The system of increasing print orders for digital photographs stored online as in claim 7 wherein said album owner pre-selects a dollar amount limit per viewer.

9. The system of increasing print orders for digital photographs stored online as in claim 7 wherein said album owner selects a total dollar amount limit for all viewers of said online album.

10. The system of increasing print orders for digital photographs stored online as in claim 7 wherein said viewer pays a portion of a cost of photographic prints ordered from said online album.

11. The system of increasing print orders for digital photographs stored online as in claim 7 wherein said album owner enters mailing address information for said viewer.

12. The system of increasing print orders for digital photographs stored online as in claim 7 wherein an index print postcard is mailed to said viewer.

13. A system for increasing print orders from digital photographs stored online comprising:
means for storing digital photographs in an online album;
means for entering album owner credit card information online;
means for transmitting an internet link to at least one viewer; and
means for notifying said viewer that photographic prints ordered from said online album have been prepaid.

14. The system for increasing print orders from digital photographs stored online as in claim 13 wherein an order from said viewer is taken for photographic prints.

15. The system for increasing print orders from digital photographs stored online as in claim 13 wherein said photographic prints are delivered to said viewer.

16. The system for increasing print orders for digital photographs stored online as in claim 13 wherein said album owner pre-selects a dollar amount limit per viewer.

17. The system for increasing print orders for digital photographs stored online as in claim 13 wherein said album owner selects a total dollar amount limit for all viewers of said online album.

18. The system for increasing print orders for digital photographs stored online as in claim 13 wherein said album owner and said viewer each share a portion of the cost of photographic prints ordered from said online album.

19. The system for increasing print orders for digital photographs stored online as in claim 13 wherein said album owner enters mailing address information for said viewer.

20. A method of ordering prints of digital photographs stored online comprising:
storing digital photographs in an online album;
entering album owner credit card information online;
transmitting an Internet link to at least one viewer;
notifying said at least one viewer that photographic prints ordered from said online album have been prepaid; and
wherein an index print postcard is mailed to said viewer.

21. The method of ordering prints of digital photographs stored online as in claim 20 wherein a toll-free number is included on said index print postcard for placing orders for photographic prints.

22. The method of ordering prints of digital photographs stored online as in claim 20 wherein a personal identification number is required to order photographic prints.

23. The method of ordering prints of digital photographs stored online as in claim 20 wherein said index card and said personal identification number are taken to a retail store for print fulfillment.

24. A system of increasing print orders for digital photographs stored online comprising:
storing digital photographs in an online album;
entering album owner credit card information online;
transmitting an Internet link to selected viewers;
notifying said viewers that photographic prints selected from said online album have been prepaid;
taking an order from said viewer for photographic prints;
delivering said photographic prints to said viewer; and
wherein an index print postcard is mailed to said viewer.

25. The system of increasing print orders for digital photographs stored online as in claim 24 wherein a toll-free number is included on said index print postcard for placing orders for photographic prints.

26. The system of increasing print orders for digital photographs stored online as in claim 24 wherein a personal identification number is required to order photographic prints.

27. A system for increasing print orders from digital photographs stored online comprising:
means for storing digital photographs in an online album;
means for entering album owner credit card information online;
means for transmitting an Internet link to at least one viewer;
means for notifying said viewer that photographic prints ordered from said online album have been prepaid; and
wherein an index print postcard is mailed to said viewer.

28. The system for increasing print orders for digital photographs stored online as in claim 27 wherein a toll-free number is included on said index print postcard for placing orders for photographic prints.

29. The system for increasing print orders for digital photographs stored online as in claim 27 wherein a personal identification number is required to order photographic prints.

30. A method of ordering prints of digital photographs stored online comprising:
storing digital photographs online;
entering owner credit card information online;
transmitting an electronic link to at least one viewer;
notifying said at least one viewer that photographic prints ordered from said online album have been prepaid;
receiving an order from said to at least one viewer; and
providing photographic prints to said at least viewer.

31. A method of ordering digital prints as in claim 30 wherein said electronic link is in the e-mail message.

32. A method of ordering digital prints as in claim 30 wherein said electronic link is a plurality of thumbnail digital images.

33. A method of ordering digital prints as in claim 30 comprising the additional steps of:
printing an index print of said digital photographs;
sending said index print to an additional viewer;
selecting desired photographic prints from said index print;
transmitting print order information to a service provider; and
sending photographic prints to said additional viewer.

34. A method of ordering digital prints as in claim 33 wherein said index print is sent to said additional viewer in an envelope.

35. A method of ordering digital prints as in claim 33 wherein said additional viewer selects desired photographic prints by placing a telephone call to said service provider.

36. A method of ordering digital prints as in claim 33 wherein said additional viewer selects desired photographic prints by marking said index print and returning said index print to said service provider.

37. A method of ordering prints of digital photographs stored online comprising:
storing digital photographs online;
entering owner credit card information online;
printing an index print of said digital photographs;
sending said index print to at least one viewer;
notifying said at least one viewer that said photographic prints ordered from said index print have been prepaid;
selecting desired photographic prints from said index print;
transmitting print order information to a service provider; and
sending photographic prints to said at least one viewer.

38. A method of ordering prints as in claim 37 wherein said index print is comprised of a plurality of thumbnail digital images.

39. A method of ordering prints of digital photographs stored online comprising:
storing digital photographs online;
entering owner billing information online;
transmitting an Internet link to at least one viewer; and
notifying said at least one viewer that photographic prints ordered from said online photographs have been prepaid.

40. The method of ordering prints of digital photographs stored online as in claim 39 wherein said owner pre-selects a dollar amount limit per viewer.

41. The method of ordering prints of digital photographs stored online as in claim 39 wherein said owner selects a total dollar amount limit for all viewers of said online digital photographs.

42. The method of ordering prints of digital photographs stored online as in claim 39 wherein said owner enters mailing address information for said viewer.

43. The method of ordering prints of digital photographs stored online as in claim 39 wherein an index print postcard is mailed to said viewer.

44. A system of increasing print orders for digital photographs stored online comprising:
storing digital photographs in an online album;
entering album owner billing information online;
transmitting an Internet link to at least one viewer;
notifying said viewer that photographic prints ordered from said online album have been prepaid;
taking an order from said viewer for photographic prints; and
delivering said photographic prints to said viewer.

45. The system of increasing print orders for digital photographs stored online as in claim 44 wherein said album owner pre-selects a dollar amount limit per viewer.

46. The system of increasing print orders for digital photographs stored online as in claim 44 wherein said album owner selects a total dollar amount limit for all viewers of said online album.

47. The system of increasing print orders for digital photographs stored online as in claim 44 wherein said album owner enters mailing address information for said viewer.

48. The system of increasing print orders for digital photographs stored online as in claim 44 wherein an index print postcard is mailed to said viewer.

49. A method of ordering prints of digital photographs stored online comprising:
storing digital photographs online;
entering owner payment information online;
printing an index print of said digital photographs;
sending said index print and a personal identification number to at least one viewer;
notifying said at least one viewer that said photographic prints ordered from said index print have been prepaid;
selecting desired photographic prints from said index print;
delivering print order information to a service provider; and
delivering photographic prints to said at least one viewer.

50. A method of ordering prints as in claim 49 wherein said index print is comprised of a plurality of thumbnail digital images.
